(19) United States
(12) Patent Application Publication
(10) Pub. No.: US 2008/0314241 A1
(43) Pub. Date: Dec. 25, 2008

(54) Piston Comprising a Circumferential Radial Recess Located Below an Annular Groove

(75) Inventors: Ralf Buschbeck, Mockmuhl (DE); Johannes Spermann, Bad Wimpfen (DE); Christina Hefele, Offenau (DE); Alfred Alexander Blau, Neckarsulm (DE)

Correspondence Address: YOUNG & BASILE, P.C., 3001 WEST BIG BEAVER ROAD, SUITE 624, TROY, MI, 48084, US

(73) Assignee: KS-KOLBENSCHMIDT GMBH, Neckarsulm (DE)

(21) Appl. No.: 12/065,578

(22) PCT Filed: Aug. 2, 2006
(86) PCT No.: PCT/EP06/07637

§ 371 Date: Jun. 5, 2008

(30) Foreign Application Priority Data
Sep. 3, 2005 (DE) DE102005041908.9

(51) Int. Cl. F16J 1/00; B23P 15/10

(52) U.S. Cl. 92/222; 29/888.049

(57) ABSTRACT

A piston having a top part and an adjacent shaft part. The top part of the piston is provided with a field of rings encompassing at least one annular groove. A circumferential radial recess is located in the region between the upper edge of the shaft part and the annular groove. The upper diameter of the recess is smaller than the lower diameter of the recess.

The invention relates to a piston for an internal combustion engine in accordance with the features of claim 1.

Pistons for internal combustion engines with a top part and an adjacent shaft part are universally known. The upper part has a field of rings which comprises at least an annular groove, usually three annular grooves, where an oil scraper ring is inserted in the at least one annular groove and supported during piston operation against the cylinder inner wall of the internal combustion engine, or slides along said cylinder wall. This area of the piston and also of the oil scraper ring are severely stressed during piston operation so that damage can result if there is insufficient strength because of defective geometries. At the same time it is necessary and known to provide a recess below the oil scraper ring in order to be able to remove the collected oil.

This recess, however, is subject to special design requirements since with faulty or wrong geometry layout for this recess, the consequence is a weakening in the area between the upper edge of the shaft part and the lower edge of the piston top part. Such faulty designs in the form of a chamfer or a recess result in unacceptably small, i.e. marginal, contact surfaces for the oil scraper ring or in shorter load-bearing shaft lengths so that the piston overall is weakened as a result and consequently cannot be highly stressed.

The object of the invention is, therefore, to improve a generic piston [to the effect] that the disadvantages mentioned initially are avoided.

This object is achieved by the features of claim 1.

In accordance with the invention, a circumferential radial recess is located, as before, in the area between the upper edge of the shaft part and the annular groove, specifically the lower edge of the lowest annular groove, where the upper diameter, meaning in the area of the lower edge of the lowest annular groove, of the recess is smaller than the lower diameter, meaning in the area of the upper edge of the shaft part, of the recess. Several advantages are achieved as result of this geometry. First, there is an improvement (enlargement) of the contact surface of the oil scraper ring in the lower ring groove, while, on the other hand, the load-bearing length of the shaft is increased at the same time and the shape for the volume of oil to be removed or stored in the area of the upper edge of the shaft part is optimized (optimization of cross-section). This geometric design for the recess has the additional advantage that oil scraper rings with a small radial width can be used since with such oil scraper rings the lower flank of the ring requires an optimized, i.e. sufficiently large, contact surface. If the upper edge (i.e. the diameter of the fourth ring land) in the previously known geometries (chamfer or recess) were to be enlarged, this would necessarily result, with a constant oil volume, in an axially high chamfer (recess). This would require compromises in designing the piston shaft profile and, above all, negatively affect, i.e. degrade, the load capacity of the piston and its noise characteristics. The invention eliminates these disadvantages in an advantageous manner, since now the lower ring flank finds an optimized contact surface for the oil scraper ring, specifically for a ring of this type with a small radial width, without the shaft part of the piston being weakened with a simultaneously constant oil volume. Consequently, lower oil consumption and optimized noise characteristics result during piston operation in the internal combustion engine. Furthermore, it is of particular advantage that the invention makes possible the use of particularly flexible oil scraper rings, specifically the three-part versions, in geometrically borderline crank drives with short pistons (i.e. low compression height). Similarly, the known disadvantage that difficulties can result during the installation of the oil scraper ring with radially narrow steel oil rings is eliminated. With the previous geometries for the recess, it can happen because of the small diameter of the fourth ring land that the steel oil ring leaves the ring groove axially, i.e. jumps off with possible resulting damage to the internal combustion engine.

In a further refinement of the invention, the recess has an approximately V-shaped cross-section. An adequately large space is thereby created for the oil which is to be collected or removed, where the axial height of the recess is minimized and the upper edge is given the greatest possible diameter so that a sufficiently large contact surface is available for the oil scraper ring without reducing the load-bearing shaft length which would result in weakening the piston.

In a further refinement of the invention, the shape of the recess from the lower edge of the annular groove to approximately the center of the recess is shallower than the shape of the recess from the center in the direction of the upper edge of the shaft part. As a result, the area between the lower edge of the annular groove and the upper edge of the recess is configured such that, on the one hand, the necessary contact surface for the oil scraper ring is available in the lower annual groove and, on the other hand, with sufficient oil volume the necessary strength (load bearing ability for the oil scraper ring) is realized. In contrast, the shape of the recess from its center in the direction of the upper edge of the shaft part is steeper so that the oil scraped off can be collected and removed more effectively.

Different embodiments of the invention to which it is, however, not limited are shown in the Figures.

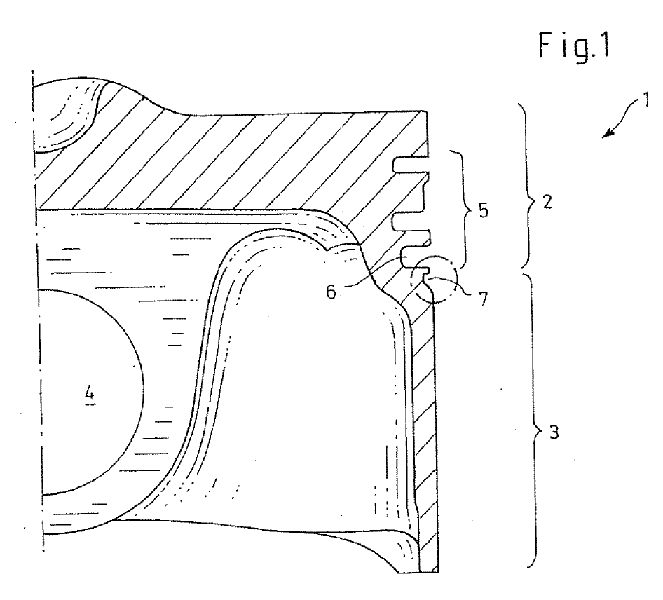

FIG. 1 shows a section through a piston shown three-dimensionally,

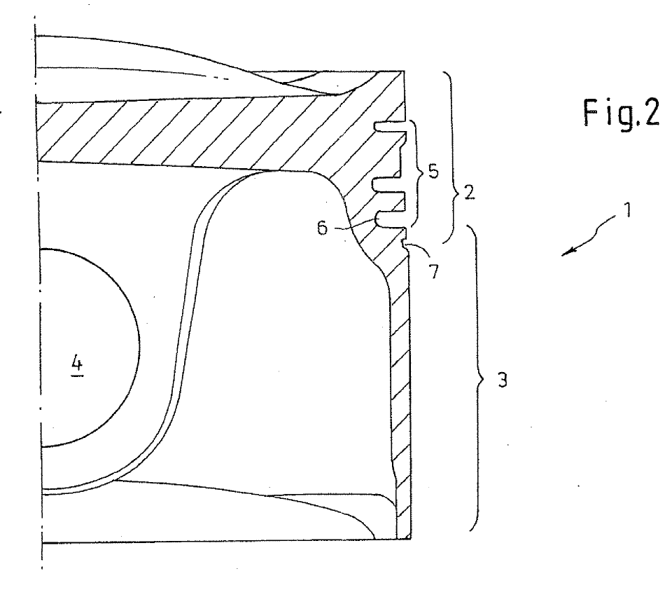

FIG. 2 shows a sectioned drawing of a piston from FIG. 1,

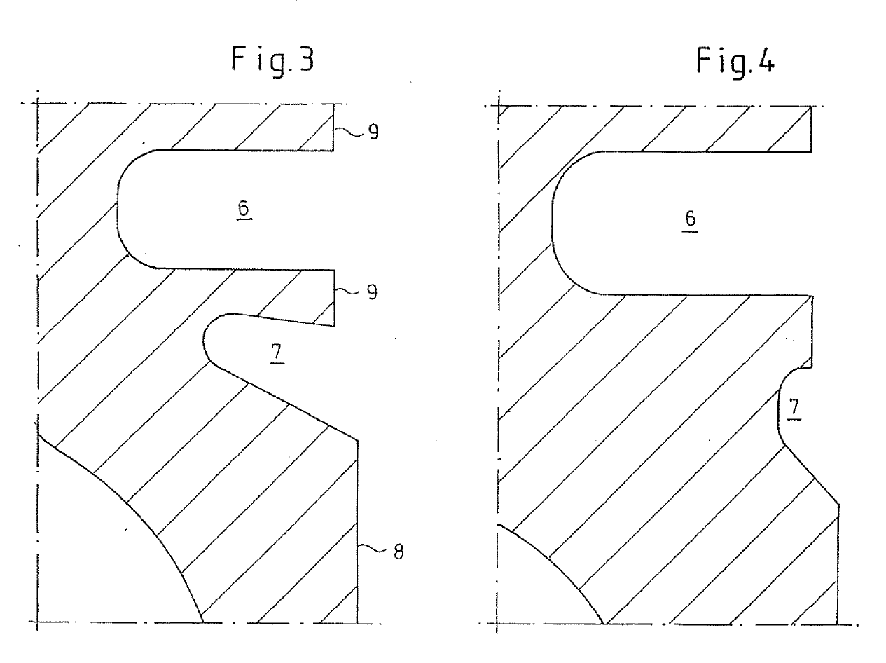

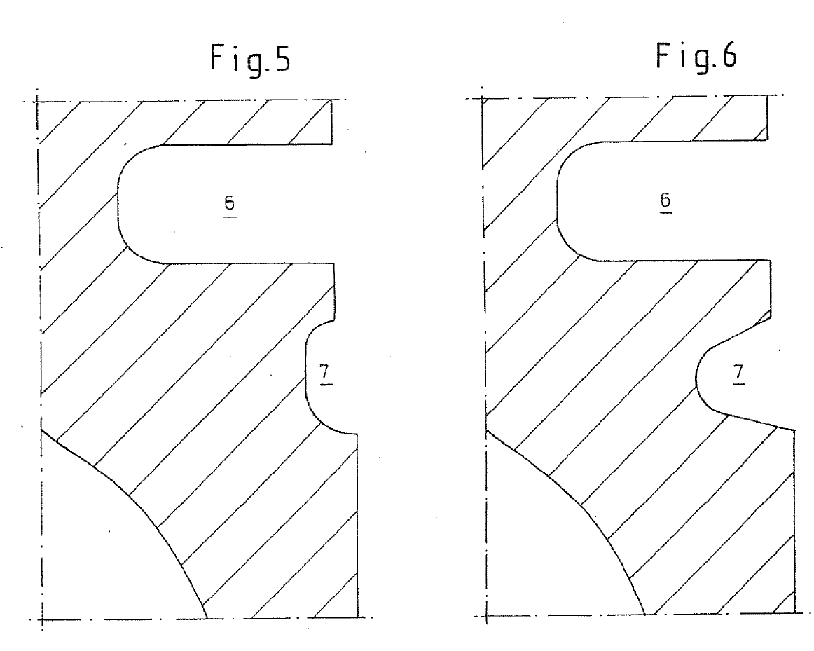

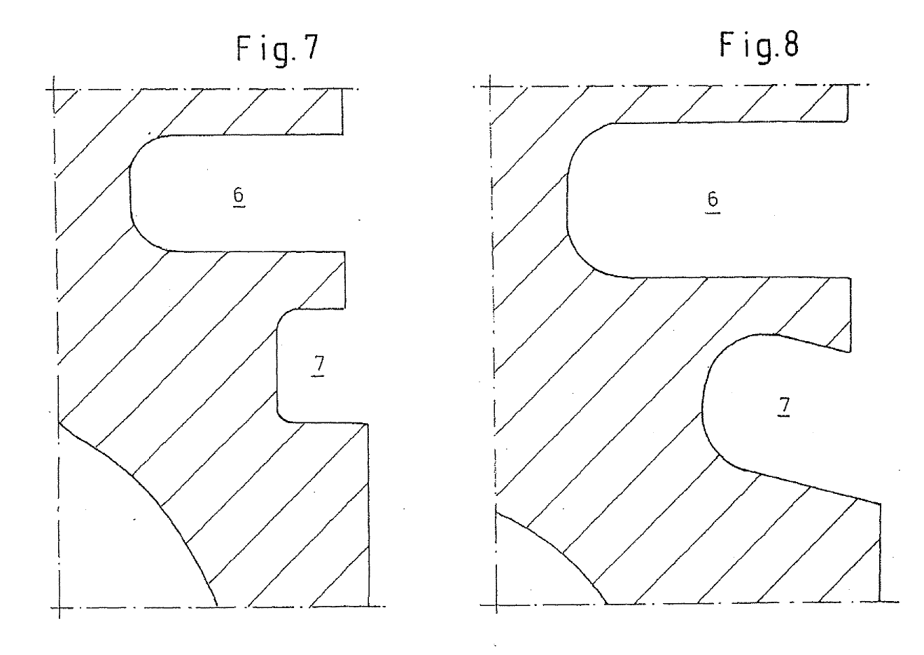

FIGS. 3 to 10 show detailed views of different embodiments of the recess in the transitional area from the piston upper part to the piston lower part.

In FIG. 1 the reference numeral 1 identifies a piston shown partially in cross-section which is configured as a finished single-piece piston, where the invention can be used in multi-piece pistons, specifically articulated pistons.

The piston 1 has a piston upper part 2 and an adjacent shaft part 3, where in the area of the shaft part 3 there is a piston-pin bore 4 in an intrinsically known way to accommodate a piston pin (not shown). Other design features of the piston 1 are present in the normal way, but this will not be discussed further to simplify the presentation of the invention.

The piston upper part 2 has, in a similarly known way, a field of rings 5, where there are three ring grooves of which the lowest ring groove is given the reference numeral 6. Below the lowest ring groove 6, i.e. in the area of the transitional area from the piston upper part 2 into the shaft part 3, a circumferential radial recess 7 is located which has the special feature in accordance with the invention that the upper diameter, i.e. the upper edge of the recess 7, is smaller than the lower diameter of the recess, i.e. in the area of the shaft part 3. Thus, not only can the oil by collected by the oil scraper ring in the annular groove 6 be accommodated in the recess 7, but the axial height of the recess 7 is minimized and the upper edge of the recess 7 offers the greatest possible diameter for the necessary contact surface of the oil scraper ring located, but not shown, in the annular groove 6 without reducing the load-bearing shaft length.

FIG. 2 shows for clarification purposes one more sectional view of a piston from FIG. 1.

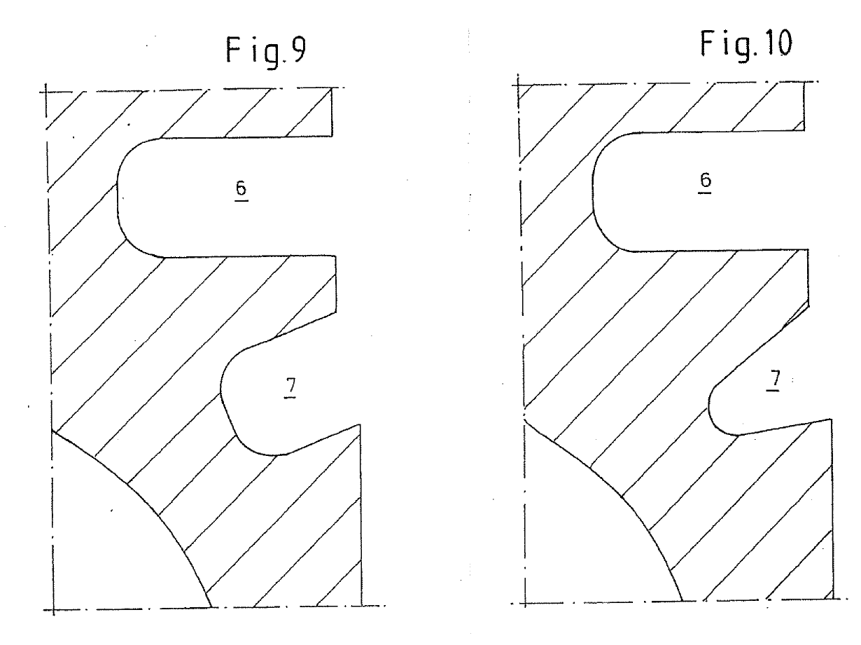

FIGS. 3 to 10 show detailed views of different embodiments of the recess 7 in the transitional area from the piston upper part 2 to the piston lower part 3. It can be seen that different geometric shapes can be used to enlarge the overall contact surface of the oil scraper ring without compromising the strength and load-bearing ability of the piston. FIG. 3, which is representative of the other Figures, shows that the diameter in the area of the piston lower part 3, more precisely in the area of a shaft wall 8, is greater than the diameter in the area of the field of rings 5, more precisely of the ring walls 9. In the case of the downward aligned recesses 7 as shown in FIGS. 9 and 10, oil can collect which contributes to lubrication. A similar or even almost identical effect ensues with the recesses 7 as shown in the remaining Figures because of the upward and downward motion of the operating piston.

### REFERENCE NUMERAL LIST

1. Piston
2. Piston upper part
3. Shaft part
4. Piston-pin bore
5. Field of rings
6. Ring groove
7. Recess
8. Shaft wall
9. Ring wall

1. A piston having a piston upper part and an adjacent shaft part where the piston upper part has a field of rings with at least one ring groove the piston comprising:
a circumferential radial recess located in the area between an upper edge of the shaft part and the ring groove, where an upper diameter of the recess is smaller than a lower diameter of the recess.

2. The piston from claim 1, where the recess has an approximately V-shaped cross-section.

3. The piston from claim 1, where the shape of the recess from the lower edge of the ring groove to approximately a center of the recess is shallower than the shape of the recess from the center in the direction of the upper edge of the shaft part.

4. The piston from claim 1 where the recess is introduced with the casting of a piston blank and, after the casting of the piston blank, is brought to the corresponding shape by fine machining.

5. The piston from claim 1 where a piston blank is cast where the piston blank initially has no recess and the recess is brought to its corresponding shape by re-working.

6. A method of manufacturing a piston comprising the steps of:
forming a piston with a piston upper part and an adjacent shaft part;
forming a field of rings in the piston upper part with at least one ring groove;
forming a circumferential radial recess in the area between an upper edge of the shaft part and the at least one ring groove; and
forming an upper diameter of the recess smaller than a lower diameter of the recess.

7. The method of claim 6 comprising:
the steps of forming a piston including casting a piston blank; and
further including the steps of:
introducing the recess contemporaneous with the casting of the piston blank; and
after casting, fine machining the recess to a final shape.

8. The method of claim 6 comprising:
the steps of forming piston including casting a piston blank initially without a recess and further including the step of:
introducing the recess into the piston blank in a final shape by re-working the piston blank.
